(19) United States
(12) Patent Application Publication
(10) Pub. No.: US 2022/0144537 A1
(43) Pub. Date: May 12, 2022

(54) CAPSULE AND SYSTEM FOR PREPARING A LIQUID FOOD PRODUCT

(71) Applicant: DELICA AG, Buchs AG (CH)

(72) Inventors: Olivia KURTZ, Zürich (CH); Raphael GUGERLI, Aesch (CH); Roland AFFOLTER, Möriken (CH); Martin WÜTHRICH, Ziefen (CH); Christoph BRUNSCHWILER, Baden (CH)

(21) Appl. No.: 17/433,840

(22) PCT Filed: Feb. 28, 2020
(86) PCT No.: PCT/EP2020/055330

§ 371 Date: Aug. 25, 2021

(30) Foreign Application Priority Data
Mar. 1, 2019 (EP) 19160367.9

(51) Int. Cl. B65D 85/804; A47J 31/40

(52) U.S. Cl. CPC B65D 85/8064; A47J 31/407

(57) ABSTRACT

A system comprising a capsule (1) and a capsule receptacle (31) of a preparation machine (30), wherein a sealing lip (10) corresponds with a groove (33) of the capsule receptacle (31) in such a way that the sealing lip (10) is received in the groove (33) and enables a tight connection with a contact surface (32) of the capsule receptacle (31).

The present invention relates to a capsule and a system for preparing a liquid food product. Typically, for the preparation of a liquid foodstuff, the capsule is enclosed in a brewing chamber of the preparation machine, wherein a capsule receptacle moves relative to a closure plate of the machine and forms a sealed connection with the flange of the capsule. The capsule receptacle may be provided on its side facing the flange of the capsule with grooves or scores, which result from wear in the course of use or are deliberately provided by the machine manufacturer. Various capsules and systems are already known from the prior art.

For example, EP 1 654 966 A1, EP 1 849 715 A1 and EP 2 151 313 A1 disclose a capsule made of aluminium with a flange, wherein a sealing element made of a different material is arranged on the flange. The disadvantage of these capsules is that the additional material in production requires a further process step and thus makes the capsule more expensive. Furthermore, the recycling of the capsules is made considerably more difficult.

WO 2014/184652 A1 and WO 2014/184651 A1 describe a capsule which deforms strongly under the action of the enclosing element and whose area of the flange is even pulled around a front edge of an enclosing element of the brewing chamber. This deformation requires high forces to create a successful seal.

WO 2016/041596 A1 discloses another capsule which has a sealing lip on its flange, the sealing lip being intended to conform to the contours of the enclosing element. Despite deformation of the sealing lip, a reliable seal cannot be achieved.

It is the object of the invention to overcome the disadvantages of the prior art. In particular, a capsule and a system shall be provided which allows a simple and reliable sealing between capsule and capsule holder of the machine. Furthermore, the capsule should be easy and inexpensive to manufacture and the material of the capsule should be recyclable.

This task is solved by the devices defined in the independent patent claims. Further embodiments result from the dependent patent claims.

A capsule according to the invention for the preparation of a liquid food comprises a capsule body with a side wall and with a bottom, as well as a lid closing the capsule body. The capsule body is preferably rotationally symmetrical and/or frustoconical in shape. The side wall and the base may be formed in one piece. The capsule body and the lid form a receiving space for receiving at least one substance for preparing the liquid foodstuff. The capsule body has a circumferential flange-shaped rim with a sealing surface for tightly connecting the lid to the capsule body. On a base of the circumferential rim opposite the sealing surface, a circumferential protruding sealing lip is arranged for sealed cooperation with a contact surface of a capsule receptacle of a preparation machine. The sealing lip is hollow and has two legs which form a substantially right angle with the sealing surface of the flange-shaped rim. The sealing lip has a height of at least 1.0 mm measured from the sealing surface of the flange-shaped rim. Advantageously, the height is between 1.1 mm and 1.8 mm, preferably between 1.2 mm and 1.6 mm, particularly preferably between 1.3 mm and 1.4 mm. To ensure the seal between the capsule and the enclosing element of the machine, at least one of the following features is required:
the sealing lip is shaped and dimensioned in such a way that it can absorb at least a force of 500 N, preferably at least 650 N, particularly preferably at least 800 N, substantially without plastic deformation, and/or
the sealing lip has a width between 0.4 mm and 0.9 mm, preferably between 0.5 mm and 0.8 mm, particularly preferably between 0.6 mm and 0.7 mm, and/or
the sealing lip is arranged at a radial distance between 15.8 mm and 16.3 mm, preferably between 15.9 mm and 16.2 mm, particularly preferably between 16.00 mm and 16.15 mm, from a central axis of the capsule body.

Here and in the following, the following definitions apply:

A contact surface of a capsule receptacle is understood to be that area of the capsule receptacle of a machine which clamps the capsule, in particular the flange-like rim of the capsule, with a counterpart of the machine and creates a sealed connection between the capsule and the capsule receptacle by this clamping action. This is thus a front area of the capsule receptacle in the closing direction. In machines available today, this contact surface is sometimes provided with radially running grooves or scores and may also have a circumferential groove.

A substantially right angle is understood to be an angle in the range of 90°±10°, preferably ±8°, particularly preferably ±7°.

The force applied to the sealing lip is applied in the axial direction of the capsule and perpendicular to a highest edge of the sealing lip. The tool for measuring the force should have a flat surface which is perpendicular to the axial direction of the capsule.

By substantially without plastic deformation it is understood that under the action of the force, as defined above, elastic deformation of the sealing lip is permissible, but that the sealing lip returns to its original shape after the force is removed. To check this characteristic, a force-displacement diagram can be used to record the load on the sealing lip perpendicular to its highest point. It is characteristic for such an elastic deformation if the characteristic curve is linear at a force between 100 N and 500 N, preferably between 100 N and 650 N, especially preferably between 100 N and 800 N. After the force is removed and the force-displacement diagram is determined again, the new characteristic curve coincides with the previously recorded characteristic curve in the specified force range.

The width of the sealing lip is measured halfway between the highest point or the highest edge of the sealing lip and the sealing surface.

The radial distance of the sealing lip to the central axis of the capsule refers to the distance of the highest edge of the sealing lip to the central axis.

By forming the sealing lip on the flange-like rim of the capsule, a simple and inexpensive seal can be created. No additional elements are necessary.

The design of the sealing lip as a hollow sealing lip allows, for example, a one-piece design of the flange-like rim, for example by deep-drawing a metallic material. Accordingly, the capsule can be manufactured at low cost.

The alignment of the legs of the sealing lip substantially at a right angle to the sealing surface increases the stability of the sealing lip so that it is not compressed or tilts away when a contact force of the contact surface of the capsule receptacle is applied.

With the specified height of the sealing lip, an initial sealing is made possible by the mechanical closing of the brewing chamber, which is sufficient for the start of an extraction. Tests have shown that a lower height does not meet the requirements and causes a higher leakage.

The high force that can be absorbed by the sealing lip ensures that the sealing lip is not deformed unnecessarily and that no folds are formed by the deformation that would promote leakage.

The chosen width of the sealing lip is advantageous because this width makes it easy to realise a stable construction in the area of the highest edge by means of a radius of curvature. Furthermore, this width is advantageous for machines with a capsule receptacle that has a circumferential groove. The sealing lip can engage in this groove and be supported in the groove on both sides. Accordingly, two circumferential contact lines are formed, which optimise the sealing effect.

The radial distance of the sealing lip is selected so that it meets the contact surface of the capsule receptacle. In particular in machines with a capsule receptacle that has a circumferential groove, the radial distance is selected so that it corresponds approximately to a radius of the circumferential groove.

Thus, the sealing lip at least partially meets the groove and optimises the sealing effect by two circumferential contact lines.

The capsule body, the flange-shaped rim and the sealing lip can be designed in one piece. Accordingly, a cost-effective production of the capsule is made possible. For example, the capsule can be manufactured by sintering, injection moulding, pressing or forming, in particular by deep drawing, thermoforming, internal or external high-pressure forming.

The sealing lip can be arranged at a radial distance of between 0.4 mm and 0.9 mm, preferably between 0.5 mm and 0.75 mm, particularly preferably between 0.55 mm and 0.65 mm, from the side wall of the capsule body. The distance between a virtual intersection of the side wall with the sealing surface and a virtual intersection of the inner leg of the sealing lip with the sealing surface is measured. Such dimensioning is advantageous if the capsule receptacle is thin-walled in its front region and thus has a narrow contact surface or if the capsule receptacle has a circumferential groove. Accordingly, an area of the capsule receptacle can be accommodated between the sealing lip and the side wall, again forming two circumferential contact lines for improved sealing.

The sealing lip can be round at its highest point and in particular have a radius of curvature between 0.15 mm and 0.45 mm, preferably between 0.20 mm and 0.40 mm, particularly preferably between 0.25 mm and 0.35 mm. A round design of the sealing lip stabilises the construction and increases the resistance to deformation. The radius is measured on the outside of the sealing lip at the highest point. In addition, a round design prevents excessive wear of the capsule receptacle when it comes into contact with the sealing lip. Preferably, the rounding extends from the highest point of the sealing lip to the area of the legs.

In the transition of the sealing lip to the base of the flange-shaped rim, a rounding with a radius between 0.1 mm and 0.5 mm, preferably between 0.1 mm and 0.4 mm, particularly preferably between 0.1 mm and 0.3 mm, may be provided. Preferably, the radius between the inner leg and the base facing the side wall is larger than the opposite radius between the outer leg and the base. The rounding or the radius of curvature is measured on the side facing the sealing lip, i.e. the side facing away from the sealing surface. A design with round transitions simplifies the production of the capsule and also has a positive influence on the stability of the sealing lip.

Preferably, the flange-shaped rim has no further sealing contours. In particular, the flange-shaped rim has exactly one sealing lip. By designing only one sealing lip, the production is simplified and the capsule can be produced at low cost.

The sealing lip can be formed from a metal, in particular from aluminium or an aluminium alloy, or a laminate with at least one layer of a metal, in particular from aluminium or an aluminium alloy. The metal may be selected from the group comprising tinplate, chromium steel, titanium, aluminium, tin, copper, brass, or an alloy thereof. A laminate comprising several metal layers or a combination of plastic and metal layers is also conceivable. Depending on the application or requirements of the foodstuff, the capsule can be made with different materials or coated accordingly. Coatings can be applied, for example, by vapour deposition, enamelling or anodising. The most cost-effective variant can be selected in each case.

The material can have a thickness of 0.1 mm±0.05 mm, preferably ±0.03 mm, particularly preferably ±0.01 mm in the area of the sealing lip. Depending on the material selected, the material thickness can vary in order to be able to guarantee the required sealing effect. A thin material thickness reduces the material costs of the capsule.

The side wall of the capsule body can have a diameter of 30.1 mm ±0.2 mm, preferably ±0.1 mm, particularly preferably ±0.05 mm. In this case, the diameter is measured at a virtual intersection of the side wall with the sealing surface. The diameter is preferably adapted to the inner diameter of the capsule receptacle of the machine. However, it has been shown that an optimal fit can be achieved with the selected diameter, which neither jams in conventional machines due to a too tight fit nor wedges due to a too large clearance. In addition, an initial seal between the side wall and the inner diameter of the capsule receptacle is already made possible and optimal centring of the capsule is ensured.

The capsule body can have a height from the bottom to the sealing surface of the flange-shaped rim between 27.0 mm and 28.5 mm, preferably between 27.5 mm and 28.0 mm, particularly preferably between 27.8 mm and 27.9 mm. The height is measured on the outside of the capsule. The suggested height is relevant to ensure correct piercing of the bottom of the capsule in conventional machines. If the capsule does not have the required height, insufficient perforation may occur, so that no or too little extraction fluid can be introduced into the capsule. If the capsule is too high, proper closure of the brewing chamber may be impeded, resulting in a malfunction of the machine in the worst case.

The capsule body may have substantially the shape of a double truncated cone with a first cone angle of 60°±5°, preferably ±2°, more preferably ±1°. The first cone angle is the cone angle in the area adjacent to the bottom of the capsule. A second cone angle may be 6°±5°, preferably ±3°, particularly preferably ±2°. The second cone angle is considered to be the cone angle in the region of the side wall. The first cone angle enables a first centring of the capsule during the closing of the brewing chamber even before the effective closing and before the contact surface of the capsule receptacle with the flange-shaped rim of the capsule. Usually, the brewing chamber of a machine is equipped with three or more piercing elements, which pierce the bottom area of the capsule when closing the brewing chamber. The first cone angle ensures that the capsule, which is not yet fixed in the capsule holder, is already aligned and centred before the piercing elements pierce the capsule. The second cone angle is essentially adapted to the inner geometry of the capsule receptacle and also ensures further centring during closing.

The capsule body can have a bottom surface with a diameter of 10 mm±1 mm, preferably ±0.5 mm, particularly preferably ±0.2 mm. The diameter is measured at the bottom in the corner point of the first cone angle. The bottom surface, together with the first cone angle and the height of the capsule, ensures the correct position of the piercing elements in relation to the capsule body.

The side wall of the capsule body may have a step-shaped widening in the area close to the basis, the widening being arranged at a distance from the sealing surface in the direction of the central axis of 3.0 mm to 7.0 mm, preferably of 4.0 mm to 6.0 mm, particularly preferably 4.5 mm to 5.5 mm. This expansion may comprise a change in the outer diameter between 0.1 mm and 2.0 mm, preferably between 0.3 mm and 1.0 mm, particularly preferably between 0.4 mm and 0.5 mm. An expansion of the capsule body near the flange-shaped rim improves the centring of the capsule in the capsule receptacle. Accordingly, the correct interaction of the sealing lip with the contact surface of the capsule receptacle can be improved. Furthermore, an initial seal is already created between the side wall and the inside of the capsule receptacle.

A capsule according to the invention for the preparation of a liquid foodstuff, in particular as described above, comprises a capsule body with a side wall and a base as well as a lid closing the capsule body to form a receiving space for receiving at least one substance. The capsule body may be rotationally symmetrical and/or frustoconical in shape. The base may be formed integrally with the side wall. The capsule has a circumferential flange-shaped rim with a sealing surface for tightly connecting the lid to the capsule body. On a base of the flange-shaped rim opposite the sealing surface, a protruding sealing lip is arranged for sealed cooperation with a contact surface of a capsule receptacle of a preparation machine. The sealing lip is hollow and has two legs which form a substantially right angle with the sealing surface of the flange-shaped rim. A leg of the sealing lip directed towards the side wall of the capsule body has a radial distance from a central axis of the capsule body, this distance being substantially equal to a distance from an outer circumferential line with an inclination of 45° relative to the axis, an outwardly directed contact surface of a capsule receptacle, to a central axis of the capsule receptacle. By substantially equal size is understood here that a ratio of the distance of the sealing lip to the central axis to the distance of the outer circumferential line to the central axis is in a range of 0.90 to 1.10, preferably in a range of 0.95 to 1.05, particularly preferably in a range of 0.99 to 1.03. The radial distance of the leg of the sealing lip directed towards the side wall from the central axis of the capsule is measured halfway between the highest point or the highest edge of the sealing lip and the sealing surface.

By forming the sealing lip on the flange-like rim of the capsule, a simple and inexpensive seal can be created. No additional elements are necessary.

The design of the sealing lip as a hollow sealing lip allows, for example, a one-piece design of the flange-like rim, for example by deep-drawing a metallic material. Accordingly, the capsule can be manufactured at low cost.

The alignment of the legs of the sealing lip essentially at a right angle increases the stability of the sealing lip so that it is not compressed or tilts away when a contact force of the contact surface of the capsule receptacle is applied.

By the selected positioning of the inner leg of the sealing lip in relation to an outer circumferential line with an inclination of 45° in relation to the axis of an outwardly directed contact surface of a capsule receptacle, it can be ensured that an outwardly directed contact surface meets the inwardly directed leg of the sealing lip in order to develop a sealing effect. Particularly in the case of capsule receptacles which have a circumferential groove in their contact surface, the outwardly directed region of the contact surface within the groove can thus interact with the inwardly directed leg of the sealing lip.

The sealing lip can be arranged at a radial distance from the side wall of the capsule body, this distance being at least equal with respect to a distance between the outer circumferential line and an inner circumferential line defined by an inclination of 45° of an inwardly directed contact surface of a capsule receptacle, in particular being greater by at least a factor of 1.05, preferably by at least a factor of 1.10. The distance between a virtual intersection of the side wall with the sealing surface and a virtual intersection of the inner leg of the sealing lip with the sealing surface is measured. Such dimensioning is advantageous if the capsule receptacle is thin-walled in its foremost region and thus has a narrow contact surface, or if the capsule receptacle has a circumferential groove. Accordingly, an area of the capsule receptacle can be accommodated between the sealing lip and the side wall, thus forming two circumferential contact lines for improved sealing.

The side wall of the capsule body can have a diameter which is at most 1.5% smaller than the diameter of a capsule receptacle, preferably at most 1.0% smaller, particularly preferably at most 0.5% smaller. The diameter of the capsule body is determined at a virtual intersection of the side wall with the sealing surface. The diameter of the capsule receptacle is determined at a virtual intersection of its inner surface with a horizontal plane spanned by the opening of the capsule receptacle. By matching the diameter of the side wall to the diameter of the capsule receptacle in this way, an optimal fit can be achieved. The capsule is not jammed due to a too tight fit, but also cannot get wedged in the capsule receptacle due to a too large clearance. In addition, an initial seal between the side wall and the inner diameter of the capsule receptacle is already made possible and an optimal centring of the capsule is guaranteed.

A fleece can be arranged in the area of the bottom of the capsule body. In this case, the fleece is arranged between the bottom of the capsule and the substance. In particular in the case of capsules in which the liquid food is prepared by passing a liquid from the base to the lid, this favours uniform wetting of the substance enclosed in the capsule. Thus, for example, channel formation in the substance can be avoided. In addition, turbulent flows can be broken and flow peaks smoothed. The substance is evenly wetted, which is an important criterion for obtaining a high-quality beverage, especially when extracting coffee. In addition, the valve effect of the fleece ensures a uniform flow regardless of the size of the openings created by the piercing means. The filling weight of the beverage substance in the capsule can be reduced for the same cup result. By reducing the filling weight, the CO₂ footprint of the beverage is smaller due to the lower substance input. In addition, a fleece prevents the penetration means of a preparation machine from being contaminated with the substance and/or prevents substance from escaping from the capsule through the piercing openings of the penetration means after removing the capsule from the machine. Furthermore, the fleece can restrict the capsule volume available for the beverage substance, which in turn can lead to an additional reduction of the beverage substance.

The fleece can be designed in such a way that it is not penetrated by the penetration means of a preparation machine. Leakage of substance after removal of the capsule from a machine is prevented.

The fleece may be fixed in an edge area of the bottom of the capsule. This reduces the risk of the penetration means of a preparation machine piercing the capsule base outside the fleece.

The fleece can be attached to the bottom over the entire surface or only in the edge area of the capsule bottom, preferably following a circular path. If the fleece is not attached over the entire surface, the elasticity of the fleece allows a certain amount of movement, so that under the pressure of the liquid flowing into the capsule, the fleece is moved towards the inside of the capsule. The fleece can also be pushed towards the inside of the capsule under the action of the penetration means of the preparation machine. Thus, the free volume inside the capsule is reduced. The substance in the capsule is correspondingly more tightly enclosed and, regardless of the orientation of the capsule, the distribution of the substance is more even. In the case of a coffee capsule, this favours the build-up of a defined filter bed. The reproducibility of the quality of the prepared foodstuff is increased even in the case of fluctuating and/or lower substance volumes. Alternatively, the fleece can also be attached to the side wall in the area of the transition from the side wall to the capsule base.

The fleece may comprise a swelling material. Thus, when the fleece is wetted, the capsule volume is additionally reduced so that the substance is more tightly enclosed. This results in an improved and more uniform quality of the prepared food.

The attachment of the fleece in the region of the capsule base or to the side wall can be achieved by sealing, preferably by heat sealing. For example, the seal has an outer diameter between 20.0 mm and 23.0 mm, preferably between 20.5 mm and 22.5, more preferably between 21.0 mm and 22.0 mm. The inner diameter of the seal can be between 17.5 mm and 20.5 mm, preferably between 18.0 and 20.0 mm, particularly preferably between 19.0 mm and 20.0 mm. The width of the seal is between 0.50 mm and 5.00 mm, preferably between 0.75 mm and 3.00 mm, particularly preferably between 0.75 mm and 1.75 mm.

The outer diameter of the fleece may be larger than the outer diameter of the seal. The edge of the fleece can be in contact with the side wall of the capsule body. In addition, the tolerances for the sealing can be chosen larger, which leads to a more favourable manufacturing process.

The sealing can be done circumferentially along a closed curve. The sealing can also be carried out in a circumferential segment-like manner. The width of the gap between two sealing areas should not be greater than 2.0 mm, preferably not greater than 1.5 mm, particularly preferably not greater than 1.0 mm.

The sealing is preferably designed in such a way that the fleece does not detach from the capsule body during preparation. Detachment of the fleece in certain areas is conceivable as long as the fleece reliably prevents substance from escaping from the openings in the capsule base created by the penetration means after preparation.

The fleece can be attached in the area of the capsule base or to the side wall in such a way that a free space is formed between the fleece and the capsule base. The distance is in the range of 0.5 mm to 2.0 mm, preferably between 0.75 mm to 1.5 mm, particularly preferably 1.0 mm. Particularly in the case of a conical design of at least a partial region of the capsule base, good mobility of the fleece can thus be ensured.

The fleece may have a grammage of 10.0 g/m2 to 55.0 g/m2, preferably 12.5 g/m2 to 28.0 g/m2. Preferably, the fleece is not calendered and does not have microperforations.

The fleece may have a dry thickness between 41 μm and 180 μm, preferably between 70 μm and 100 μm, more preferably between 75 μm and 85 μm.

The fleece may be provided with sealing fibres, preferably of polyethylene (PE). Preferably, the sealing fibres are arranged on one side only.

Preferably, the fleece is single-layered. Accordingly, no separation of the layers can occur during the preparation of the liquid food. The different design of the top side and the bottom side of the fleece must accordingly be taken into account already during its manufacture.

While the above described arrangement of a fleece is particularly advantageous in combination with the described sealing lip made of aluminium, it is understood that such a fleece arrangement may also be advantageous for other capsules and other sealing arrangements.

Another aspect of the present invention relates to a system comprising a capsule as described above and a capsule receptacle of a preparation machine, wherein the sealing lip corresponds to a groove of the capsule receptacle such that the sealing lip is received in the groove and enables a sealed connection with a contact surface of the capsule receptacle.

The sealing lip and the groove can be matched to each other in such a way that, when the capsule is enclosed between the capsule receptacle and a closure plate of the preparation machine, the sealing lip in the groove first contacts a first side wall of the groove and, during further closure, is elastically deflected until the sealing lip is supported on the second side wall of the groove opposite the first side wall. The contact or support on both sides creates an additional sealing contour and improves the sealing effect. Furthermore, it can be achieved that the sealing lip deforms laterally only in the elastic range. Accordingly, a higher sealing force can be applied to further improve the sealing effect.

The invention is explained in more detail below with reference to figures, which are merely examples of embodiments. They show:

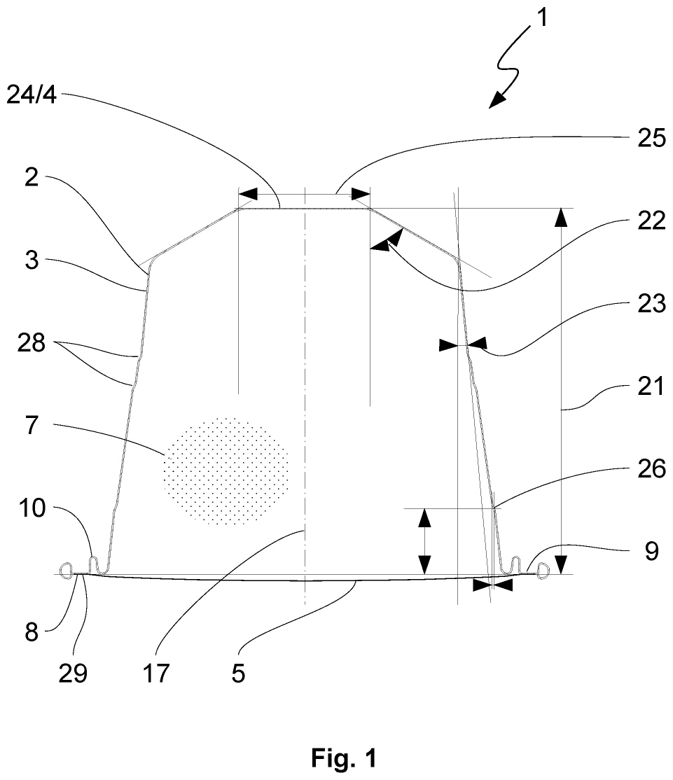

FIG. 1: a cross-section through a capsule according to the invention,

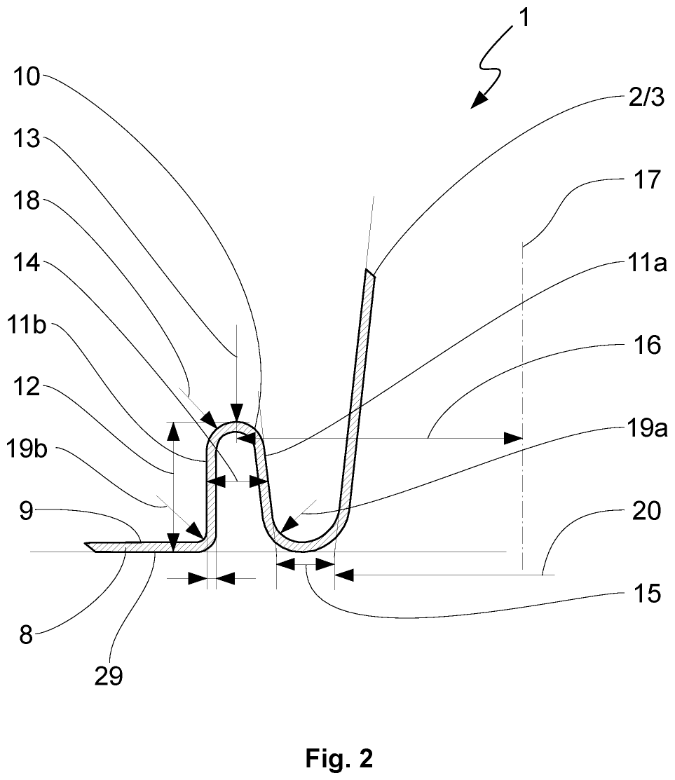

FIG. 2: an enlarged view of the area of the sealing lip of the capsule according to FIG. 1,

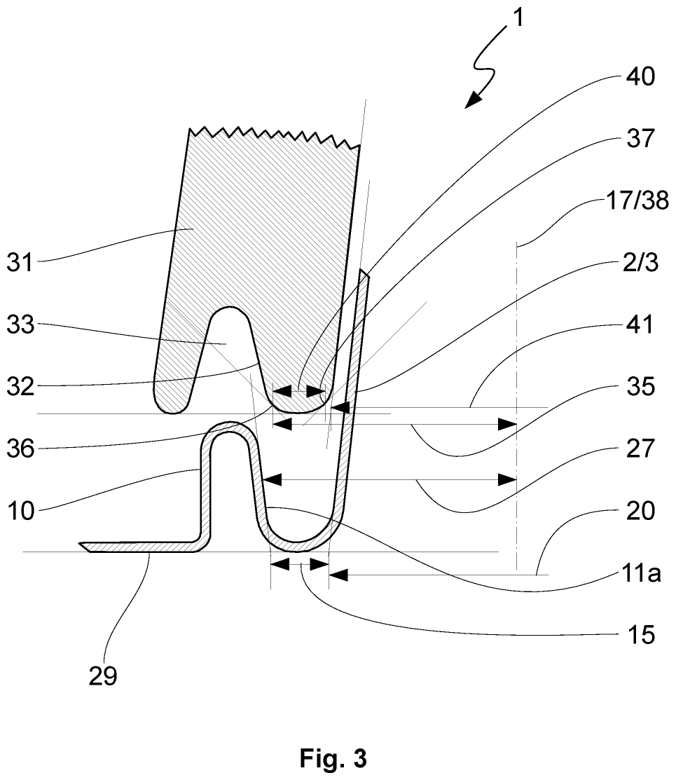

FIG. 3: the enlarged representation of the capsule according to FIG. 2, whereby a front end of a capsule receptacle is additionally drawn,

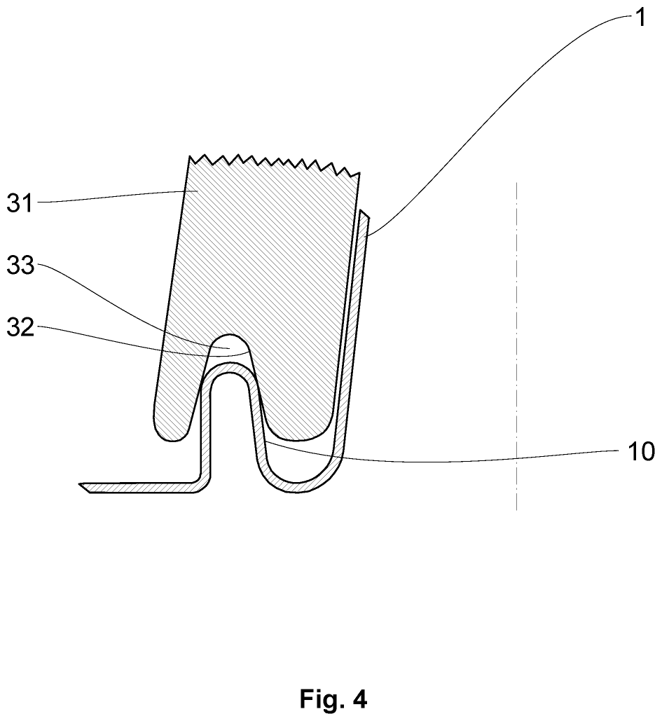

FIG. 4: the representation according to FIG. 3, whereby the capsule receptacle forms a sealed connection with the capsule, and

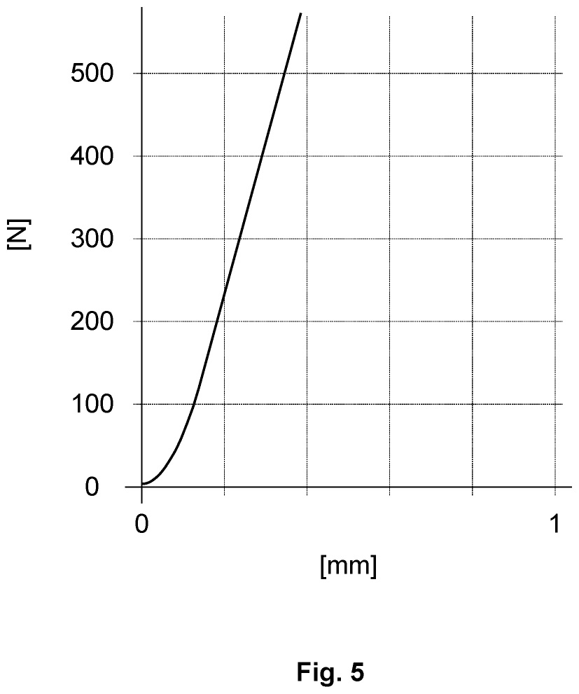

FIG. 5: an illustration of a force-displacement diagram,

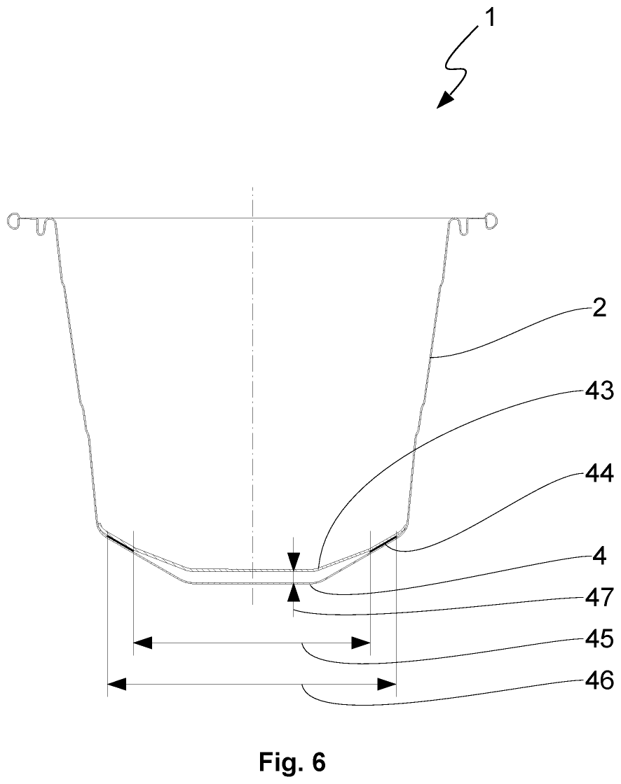

FIG. 6: a cross-section through a further embodiment of a capsule according to the invention,

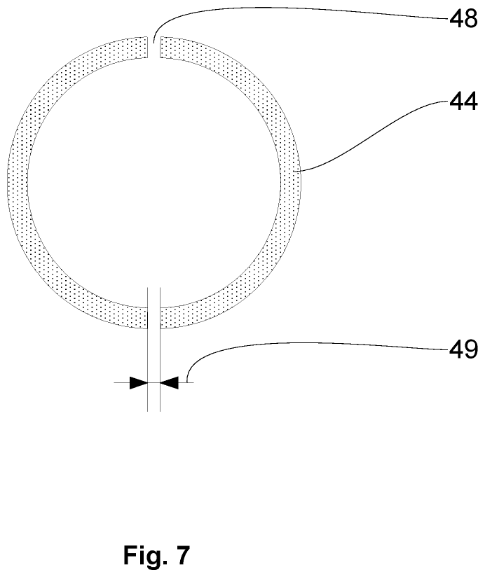

FIG. 7: a schematic representation of the seal between the capsule body and the fleece fabric according to FIG. 6.

FIG. 1 shows a cross-section through a capsule 1 according to the invention. The capsule 1 comprises a capsule body 2 with a side wall 3 and a bottom 4. The capsule body 2 has a circumferential flange-shaped rim 8 with a sealing surface 29 for fastening a lid 5. The capsule 1 and is preferably closed in an aroma- and oxygen-tight manner so that a substance 7 can be accommodated inside the capsule 1 and is enclosed by the capsule body 2 and lid 5. The capsule body 2 is rotationally symmetrical and frustoconical in shape. accordingly, the capsule body 2 has a central axis 17. The lid 5 of the capsule 1 is curved under the internal pressure prevailing in the capsule 1.

The flange-shaped rim 8 has a base 9 on the side opposite the sealing surface 29, from which a sealing lip 10 projects. The sealing lip 10 is formed around the side wall 3. The flange-shaped rim 8 has a rolled rim at its outer end, and the rim 8 could also be finished in a different way. The capsule body 2 is formed essentially in the shape of a double truncated cone. A conical surface with a first cone angle 22 of 60° projects from its base 4. Adjacent to this conical surface is another conical surface with a second cone angle 23 of approx. 6°. This second conical surface forms the side wall 3, which has several steps 26, 28. At each of these steps the cone angle and the outer diameter change minimally. The last step is a widening 26 of the side wall 3 with a diameter change of 0.4 mm. This widening is located at a distance in the axial direction between 4.7 mm and 5.4 mm from the sealing surface 29. The bottom 4 of the capsule 1 has a bottom surface 24 with a diameter 25 of 10 mm. The capsule 1 has a height 21 of 27.85 mm. The height 21 is measured between the base 4 and the sealing surface 29.

In FIG. 2 the area of the sealing lip 10 of the capsule body 2 of the capsule 1 as shown in FIG. 1 is shown enlarged. Starting from the side wall 3 of the capsule body 2, the flange-shaped rim 8 extends outwards. The flange-shaped rim 8 forms a sealing surface 29 to which the lid 5 (see FIG. 1) is attached. On the side opposite the sealing surface 29, the base 9 of the rim is visible, from which the sealing lip 10 rises. The sealing lip 10 is hollow, i.e. a corresponding recess is formed on the side of the sealing surface 29. The sealing lip 10 has an inner leg 11a directed towards the side wall 3 and an outer leg 11b directed outwards. The two legs 11a, 11b enclose an angle of 6.67°, whereby the outer leg 11b is arranged approximately perpendicular to the base 9 or to the sealing surface 29.

The sealing lip 10 has a radius of curvature 18 of 0.3 mm at its highest point. The transition from the base 9 to the outer leg 11b has a radius of curvature 19b of 0.1 mm, the transition from the base 9 to the inner leg 11a has a radius of curvature 19a of 0.3 mm. The radii are each measured on the side opposite the sealing surface 29. The sealing lip 10 has a width 14 of 0.65 mm measured at half height between the highest point of the sealing lip 10 and the sealing surface 29. The height 12 of the sealing lip 10, measured between the highest point of the sealing lip 10 and the sealing surface 29, is 1.35 mm.

The highest point or edge of the sealing lip 10 is located at a distance 16 from the central axis 17 of the capsule 1 of 16.1 mm. The sealing lip 10 has a radial distance 15 from the side wall 3 of 0.6 mm. The radial distance 15 between the sealing lip 10 and the side wall 3 is measured between the virtual intersections of the side wall 3 with the sealing surface 29 and of the inner leg 11a with the sealing surface 29 respectively. The side wall 3 of the capsule body 2 has a diameter 20 of 30.1 mm. The diameter 20 is determined at a virtual intersection of the side wall 3 with the sealing surface 29. The capsule body has a material thickness of 0.1 mm in the area of the sealing lip 10.

Also drawn is a force 13 for determining the load limit of the sealing lip 10, which acts on the highest point of the sealing lip 10 in the direction of the central axis 17. This force 13 is also used to record a force-displacement diagram as shown in FIG. 5.

FIG. 3 shows an enlarged view of the capsule 1 as shown in FIG. 2, with an additional front end of a capsule receptacle 31 being drawn before its contact with the capsule. Ideally, the central axis 17 of the capsule coincides with a central axis 38 of the capsule receptacle 31. The capsule receptacle 31 has a groove 33 at its front end facing the flange-shaped rim of the capsule, which ideally cooperates with the sealing lip 10 of the capsule.

In order for the sealing lip 10 to cooperate with the contact surface 32 of the capsule receptacle 31, a distance 27 of the inner leg 11a from the central axis 17 of the capsule 1 must be substantially equal to a distance 35 of an outer circumferential line 36 having an inclination of 45° with respect to the axis 38, of an outwardly directed region of the contact surface 32 of the capsule receptacle 31, from the central axis 38 of the capsule receptacle 31. Preferably, the two distances 27 and 35 have a ratio between 0.9 and 1.1, preferably between 0.95 and 1.05, more preferably between 0.99 and 1.03. In this case, the distance 27 of the inner leg 11a from the central axis 17 of the capsule 1 is measured halfway between the highest point or edge of the sealing lip 10 and the sealing surface 29.

Further, it is advantageous if the radial distance 15 of the sealing lip 10 from the side wall 3 of the capsule body 2 is at least equal to a distance 40 between the outer circumferential line 36 and an inner circumferential line 37 defined by an inclination of 45° of an inwardly directed portion of the contact surface 32 of the capsule receptacle 31.

The diameter 20 of the side wall 3 of the capsule body 2 is smaller than a diameter 41 of the capsule receptacle 31 by a factor of 0.8%, the diameter 41 of the capsule receptacle 31 being measured at a virtual intersection of its inner surface with a horizontal plane spanned by the opening of the capsule receptacle.

In FIG. 4, the representation according to FIG. 3 is shown, whereby the capsule receptacle 31 already forms a sealed connection with the capsule 1. The sealing lip 10 is received in the groove 33 of the capsule receptacle 31 and contacts the contact surface 32 of the capsule receptacle 31 at two circumferential lines. When closing the brewing chamber, the sealing lip 10 will contact the contact surface 32 at a first point. By increasing a contact pressure of the capsule receptacle 31 when closing the brewing chamber, the sealing lip 10 can only yield laterally until it is received in the groove 33 on both sides and is in contact accordingly. Only an elastic deformation can take place laterally. A higher contact pressure results in an improved sealing effect.

FIG. 5 shows a force-displacement diagram of a force 13 (see FIG. 2) acting in the axial direction on the highest edge of the sealing lip. The tool for measuring the force has a flat surface which runs perpendicular to the axial direction of the capsule. A linear range of the increase of the force-displacement diagram in a range from 100 N to over 500 N can be clearly seen. This linear range can only be explained by an elastic deformation of the sealing lip. That it is an elastic deformation can be verified by repeating the measurement on the same capsule. If the force-displacement diagram of the second measurement coincides with that of the first measurement, it is an elastic deformation.

FIG. 6 shows a cross-section through a further embodiment of a capsule 1 according to the invention, which additionally has a fleece 43 arranged in the region of the base 4. Otherwise, the capsule body 2 and the capsule 1 correspond to the embodiment according to FIG. 1, whereby the lid and the substance are not shown. The corresponding details are not described any further.

The fleece 43 is attached to the capsule body 2 in a conical partial region of the base 4 with a seal 44. Thereby, the fleece 43 is arranged in the capsule body 2 in such a way that a free distance 47 is formed between the capsule bottom 4 and the fleece 43. This distance 47, together with the mobility of the fleece 43, prevents the fleece from being punctured when the capsule 1 is opened with the penetration means of a preparation machine. The distance 47 is 1.0 mm. The seal 43 between the capsule body 2 and the fleece 43 follows a circular path and has an outer diameter 46 of 21.5 mm and inner diameter 45 of 19.6 mm.

The fleece 43 is not necessarily flat, but can have a truncated cone shape which runs approximately parallel to the base 4 of the capsule 1 at a distance 47.

The fleece 43 has a grammage of 25.0 g/m2 and a thickness of 77 μm. Furthermore, the fleece 43 has an air permeability greater than 300 l/sm² according to ISO 9237:1995 at a humidity of 50% and a temperature of 23° C.

FIG. 7 shows a schematic representation of the seal 44 between the capsule body 2 and the fleece 43 (see FIG. 6). The seal 44 consists of two circular segments, each separated by a sealing gap 48 with a width 49 of 1.0 mm. Of course, it is also conceivable that there is only one sealing gap or several sealing gaps, in particular three, four, five, six, seven, eight or more.

1-18. (canceled)

19. A capsule for preparation of a liquid foodstuff comprising:
a capsule body being at least one of symmetrical or frustoconical design, having a side wall and a base as well as a lid closing the capsule body for forming a receiving space for receiving at least one substance for the preparation of the liquid foodstuff,
wherein the capsule body has a circumferential flange-shaped rim with a sealing surface for tightly connecting the lid to the capsule body,
on a base of the circumferential rim, opposite the sealing surface, a circumferentially projecting sealing lip is arranged for sealingly cooperation with a contact surface of a capsule receptacle of a preparation machine,
the sealing lip is hollow and has two legs which form a substantially right angle with the sealing surface of the flange-shaped rim,
the sealing lip has at least a height of 0.0393 inches (1.0 mm) measured from the sealing surface of the flange-shaped rim,
the capsule comprises at least one of:
the sealing lip being shaped and dimensioned in such a way that the sealing lip can absorb at least one force of 500 N, essentially without plastic deformation, or
the sealing lip having a width of between 0.0157 inches (0.4) mm and 0.0354 inches (0.9) mm, or
the sealing lip being arranged at a radial distance between 0.622 inches (15.8 mm) and 0.642 inches (16.3 mm) from a central axis of the capsule body.

20. The capsule according to claim 19, wherein the base is formed integrally with the side wall.

21. The capsule according to claim 19, wherein the capsule body, the flange-shaped rim and the sealing lip are formed in one piece.

22. The capsule according to claim 19, wherein the sealing lip is arranged at a radial distance of between 0.0157 inches (0.4) mm and 0.0354 inches (0.9) mm from the side wall of the capsule body.

23. The capsule according to claim 19, wherein the sealing lip is round at its highest point.

24. The capsule according to claim 23, wherein the sealing lip, at its highest point, has a radius of curvature between 0.0059 inches (0.15 mm) and 0.0177 inches (0.45 mm).

25. The capsule according to claim 19, wherein in the transition of the sealing lip to the base of the flange-shaped rim a rounding with a radius between 0.0039 inches (0.1 mm) and 0.0197 inches (0.5 mm) is provided.

26. The capsule according to claim 25, wherein the radius facing the side wall is larger than the opposite radius.

27. The capsule according to claim 19, wherein the flange-shaped rim has no further sealing contours.

28. The capsule according to claim 27, wherein the flange-shaped rim has exactly one sealing lip.

29. The capsule according to claim 19, wherein the sealing lip is formed from a metal.

30. The capsule according to claim 19, wherein the sealing lip is formed from at least one of aluminium, aluminium alloy or a laminate with at least one layer of a metal.

31. The capsule according to claim 19, wherein the material in the region of the sealing lip has a material thickness of 0.0039 inches (0.1 mm)±0.00197 inches (0.05 mm)

32. The capsule according to claim 19, wherein the side wall of the capsule body has a diameter of 1.18 inches (30.1 mm)±0.0089 inches (0.2 mm).

33. The capsule according to claim 19, wherein the capsule body has a height from the bottom to the sealing surface of the flange-shaped rim of between 1.063 inches (27.0 mm) and 1.122 inches (28.5 mm).

34. The capsule according to claim 19, wherein the capsule body has substantially the shape of a double truncated cone with a first cone angle of 60°±5°.

35. The capsule according to claim 34 having a second cone angle of 6°±5°.

36. The capsule according to claim 19, wherein the capsule body has a bottom surface with a diameter of 0.394 (10 mm)±0.039 inches (1 mm).

37. The capsule according to claim 19, wherein the side wall of the capsule body has a step-shaped widening in the region, near the base, the widening has a diameter, at a distance from the sealing surface in a direction of the central axis, of 0.118 inches (3.0 mm) to 0.276 inches (7.0 mm) from the sealing surface in the direction of the central axis.

38. The capsule according to claim 37, wherein the widening comprises a change in the external diameter of between 0.0039 inches (0.1 mm) and 0,0079 inches (2.0 mm).

39. A capsule for preparation of a liquid foodstuff comprising:
a capsule body being at least one of symmetrical or frustoconical design, having a side wall and a base as well as a lid closing the capsule body for forming a receiving space for receiving at least one substance for the preparation of the liquid foodstuff,
wherein the capsule body has a circumferential flange-shaped rim with a sealing surface for tightly connecting the lid to the capsule body,
a protruding sealing lip is arranged on a base of the flange-shaped rim, opposite the sealing surface, for sealingly cooperating with a contact surface of a capsule receptacle of a preparation machine,
the sealing lip is hollow and has two legs which form a substantially right angle with the sealing surface of the flange-shaped rim,
a leg of the sealing lip, directed towards the side wall of the capsule body, has a radial distance from a central axis of the capsule body, this distance being substantially equal to a distance of an outer circumferential line with an inclination of 45° with respect to the axis, of an outwardly directed contact surface of a capsule receptacle, from a central axis of the capsule receptacle.

40. The capsule according to claim 39, wherein the base is formed integrally with the side wall.

41. The capsule according to claim 39, wherein the sealing lip is arranged at a radial distance from the side wall of the capsule body, and this distance is at least equally large with respect to a distance between the outer circumferential line and an inner circumferential line, defined by an inclination of 45° of an inwardly directed contact surface of a capsule receptacle.

42. The capsule according to claim 39, wherein the side wall of the capsule body has a diameter which is at most 1.5% smaller than a diameter of a capsule receptacle.

43. A system comprising a capsule according to claims 19 and a capsule receptacle of a preparation machine, wherein the sealing lip corresponds with a groove of the capsule receptacle in such a way that the sealing lip is received in the groove and enables a sealing connection with a contact surface of the capsule receptacle.

44. The system according to claim 43, wherein the sealing lip and the groove are matched to one another in such a way that, when the capsule is enclosed between the capsule receptacle and a closure plate of the preparation machine, the sealing lip in the groove first contacts a first side wall of the groove and, during further closure, is elastically deflected until the sealing lip is supported on the second side wall of the groove, which is opposite the first side wall.

45. A system comprising a capsule according to claim 39 and a capsule receptacle of a preparation machine, wherein the sealing lip corresponds with a groove of the capsule receptacle in such a way that the sealing lip is received in the groove and enables a sealing connection with a contact surface of the capsule receptacle.

46. The system according to claim 45, wherein the sealing lip and the groove are matched to one another in such a way that, when the capsule is enclosed between the capsule receptacle and a closure plate of the preparation machine, the sealing lip in the groove first contacts a first side wall of the groove and, during further closure, is elastically deflected until the sealing lip is supported on the second side wall of the groove, which is opposite the first side wall.
